(19) United States
(12) Patent Application Publication
(10) Pub. No.: US 2021/0389140 A1
(43) Pub. Date: Dec. 16, 2021

(54) LOCAL CONTROLLER FOR OPERATIONAL MODE TRANSITIONS OF DUAL-MODE VEHICLES

(71) Applicant: AT&T Intellectual Property I, L.P., Atlanta, GA (US)

(72) Inventors: Joseph Soryal, Ridgewood, NY (US); Naila Jaoude, Eatontown, NJ (US); Samuel N. Zellner, Dunwoody, GA (US)

(21) Appl. No.: 16/898,164

(22) Filed: Jun. 10, 2020

(51) Int. Cl. G01C 21/34; G08G 1/07; G08G 7/00

(52) U.S. Cl. CPC G01C 21/3423; G08G 7/00; G08G 1/07

(57) ABSTRACT

A processing system including at least one processor may obtain a navigational request for a dual-mode vehicle having two modes of operation, where the two modes of operation comprise a surface mode of operation and an aerial mode of operation, where the navigational request includes a requested transition between the two modes of operation, where the requested transition includes a requested location, and where the navigational request includes an intended destination. The processing system may next determine at least one condition of the requested location associated with the requested transition, determine based upon the at least one condition that the requested transition is not permitted at the requested location, and identify an alternate location at which the requested transition is permitted. The processing system may then transmit a response indicating that the requested transition is permitted at the alternate location.

The present disclosure relates generally to dual-mode vehicle operations, and more particularly to methods, computer-readable media, and apparatuses for identifying an alternate location at which a requested transition between operational modes of a dual-mode vehicle is permitted.

### BACKGROUND

New deconfliction (crash avoidance and safety) systems, such as for cars, remote and/or self-operating aerial vehicles, or the like, are drawing attention as government and regulatory entities debate frameworks for managing this developing area. However, safe operation may remain entirely within the calculus of a human operator or of an on-board computing system that is operating the vehicle. In addition, as dual-mode vehicles (or “flying cars”) may become more widely available, these dual-mode vehicles may coexist with conventional motor vehicles (e.g., single-mode vehicles for surface operation, or surface-operating vehicles, including internal combustion engine-powered vehicles, electric/battery powered vehicles, and hybrid vehicles) for some time, which may result in various challenges.

### SUMMARY

In one example, the present disclosure describes a method, computer-readable medium, and apparatus for identifying an alternate location at which a requested transition between operational modes of a dual-mode vehicle is permitted. For instance, in one example, a processing system including at least one processor may obtain a navigational request for a dual-mode vehicle having two modes of operation, where the two modes of operation comprise a surface mode of operation and an aerial mode of operation, where the navigational request includes a requested transition between the two modes of operation, where the requested transition includes a requested location, and where the navigational request includes an intended destination. The processing system may next determine at least one condition of the requested location associated with the requested transition, determine based upon the at least one condition that the requested transition is not permitted at the requested location, and identify an alternate location at which the requested transition is permitted. The processing system may then transmit a response indicating that the requested transition is permitted at the alternate location.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates a flowchart of an example method for identifying an alternate location at which a requested transition between operational modes of a dual-mode vehicle is permitted, in accordance with the present disclosure; and

FIG. 3 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

The present disclosure broadly discloses methods, computer-readable media, and apparatuses for identifying an alternate location at which a requested transition between operational modes of a dual-mode vehicle is permitted. In particular, examples of the present disclosure provide a system that assesses and manages transitions between two modes of operation for dual-mode vehicles, e.g., transitions between a surface mode of operation and an aerial mode of operation.

As referred to herein a dual-mode vehicle may comprise a vehicle that has two modes of operation: a surface mode of operation and an aerial mode of operation. Such a dual-mode vehicle may also be referred to as a “flying car.” In the surface mode of operation, the dual-mode vehicle may operate as a conventional surface-operating vehicle (e.g., an internal combustion engine-powered vehicle, electric/battery powered vehicle, or hybrid vehicle) that is equipped to comply with and follow all relevant laws and regulations regarding surface-based vehicular operation on roads, highways, or other rights-of-way in a relevant jurisdiction. For instance, the dual-mode vehicle may include left and right turn signals, and brake signals. The dual-mode vehicle may include headlights, taillights, a horn, and other equipment as required by law or regulation, in addition to having a size/dimensions to permit the dual-mode vehicle to operate within the lanes or other traffic markings of the roads, highways, or other rights-of-way in the relevant jurisdiction.

As referred to herein, a dual-mode vehicle is also equipped for aerial operation. For instance, the dual-mode vehicle may include one or more propellers, turbofans, jet engines, or rotors, wings, a tail, ailerons, a tail rotor, etc., and may be designed for forward-take-off-and-landing (FTOL) or vertical-take-off-and-landing (VTOL). In one example, the dual-mode vehicle may have retractable wings, rotors, and/or other components that may be extended or retracted for aerial mode operation or surface mode operation respectively. As with the surface mode of operation, the dual-mode vehicle may be equipped to comply with and follow all relevant laws and regulations regarding aerial vehicular operation in a relevant jurisdiction. In addition, for both modes of operation, the dual-mode vehicle may include automated and/or operator assist functionality, such as for surface mode operations: lane sensing/lane maintenance capability and/or lane departure warning, following distance capability, automatic braking and/or crash avoidance capability, and so forth. Similarly, for aerial mode operations, the automated and/or operator assist functionality may include: flight path maintenance, speed maintenance, heading/bearing maintenance, yaw, pitch, and/or roll maintenance, altitude maintenance, etc., warnings for any one or more of the above (e.g., a low altitude warning, an altitude change warning, a stall warning, etc.), and so forth.

It is anticipated that dual-mode vehicles may coexist with conventional automobiles for some time, raising a variety of challenges and risks. For instance, a dual-mode vehicle may needs to know the conditions as to when and where to take-off and land, which may be affected by federal/national laws, rules, regulations, and/or policies (e.g., allowed areas, restricted areas, road conditions, etc.), state and/or local laws, rules, regulations, and/or policies (e.g., allowed areas, restricted areas, road conditions, etc.), manufacturer guidelines (e.g., for weather, road geometry, other vehicles in the vicinity, road material, etc.), the presence of other dual-mode vehicles, user factors (e.g., license, experience, health status, etc.), the presence of conventional aircraft in the vicinity, the rights of way of conventional aircraft and/or conventional surface-based vehicles, and so forth.

In one example, the present disclosure includes a local controller (LC) that grants or denies permissions for dual-mode vehicles to take-off and land. The local controller may determine whether to permit or deny a transition between modes of operation (e.g., take-off or land) based upon: geographical location, road conditions, which in one example, may be determined from sensors and/or vehicles at or near the geographic location in communication with and accessible to the local controller (e.g., rain, ice, traffic density, traffic speed, etc.), weather conditions, which may similarly be determined from sensors and/or vehicles in communication with the local controller, time of the day, day of the week, time of year, etc. (for instance, 8:00 AM take-off may be allowed on weekdays but not on weekends), operator qualifications, capabilities of dual-mode vehicles, any fees associated with landing and/or taking-off, such as determined by governmental or regulatory authorities, and so on. In one example, the local controller may also pull data and policies from different places (following federal, local, and manufacturer's guidelines) and provide a decision to a dual-mode vehicle to permit or deny either landing or taking off at a requested location. In accordance with the present disclosure, when the decision is to deny the request, the local controller may also determine an alternate location, e.g., another nearby road, where the local controller determines that the conditions are able to permit the taking off or landing by the dual-mode vehicle.

Thus, in order for a dual-mode vehicle to convert itself to aerial mode, the local controller must agree and provide a permission. In one example, any violations may be reported to a penalty and enforcement system and/or relevant authorities for appropriate action. The local controller may also monitor other operations (e.g., aerial mode operations and/or surface-based operations) to ensure that the dual-mode vehicle complies with any laws, rules, regulations, or policies that are in effect. For instance, it may be required that manufacturers equip dual-mode vehicles to report operational data to local controllers as part of a registration/certification process. In addition, operators of dual-mode vehicles may be required to maintain such functionality of the dual-mode vehicles in order to continue to be permitted to operate the dual-mode vehicles in any capacity. In this regard, in one example, the local controller may be connected with a central control system, or policy manager, for updates and error-free operation (e.g., within a given region that includes a plurality of local controllers that are assigned to areas within the region). In addition, in one example, local controllers within the region may communicate and coordinate amongst themselves and with the policy manager. For instance, as noted above, when a local controller (e.g., a first local controller) determines to deny a request to transition between modes of operation, the first local controller may also determine an alternate location where the conditions are more ideal to permit the taking off or landing by the dual-mode vehicle. In such case, the first local controller may determine the alternate location within its own area to which it is assigned, or may determine the alternate location in a nearby area that is assigned to another local controller (e.g., a second local controller), where the first local controller may communicate and coordinate with the second local controller to confirm the availability of the alternate location and to indicate that the requested transition is permitted at such alternate location.

Accordingly, in one example, the local controller may be connected to all vehicles in the assigned area (e.g., aerial vehicles, surface-based vehicles, dual-mode vehicles on the ground and in the air, etc.) and may coordinate among all of such vehicles to grant permissions to dual-mode vehicles to transition between modes of operation (e.g., to take-off and land). In one example, the policy manager keeps records for all dual-mode vehicles and operator profiles up to date. When a dual-mode vehicle is in transit (including aerial and surface-based movements), other local controllers on the route may track the dual-mode vehicle and may relay information regarding the location (e.g., including altitude, if applicable), speed, etc. to enable a local controller handling a request to transition modes of operation to determine compliance of the dual-mode vehicle with any decision (e.g., did the dual-mode vehicle simply land or take-off somewhere without permission?).

In one example, a routing module of the local controller or the policy manager, or such entities in coordination with one another, may optimize the distance/timing between flying and driving between two points for a dual-mode vehicle. The local controller may provide the operator and/or the dual-mode vehicle with this information. For instance, an operator may be leaving home and intending to travel to work. The aerial mode of operation may be preferred to the extent possible due to the ability to more quickly cover a greater distance and avoid traffic. The operator may enter a route and/or intended destination into a navigation system of the dual-mode vehicle via a user interface. In addition, the operator may indicate a requested location to transition to aerial mode. For instance, if the dual-mode vehicle is in the driveway of the operator's home, the operator may indicate this location, or a location on the street immediately at the end of the driveway, for the requested location. In another example, the requested location may be implied to be the current location, or a closest location of a public road/right-of-way. The dual-mode vehicle (e.g., via the navigation system thereof) may submit the navigation plan/request to the local controller for the area. The local controller may determine that the takeoff at the requested location is not available, but that takeoff is available at several nearby locations (e.g., the next street over to the north, two blocks east and one block south, an empty road one mile away, etc.). In such case, the local controller, or the local controller in conjunction with other local controllers and/or the policy manager may determine from among several options, which may assist the operator in reaching the destination earliest. For instance, a routing module may calculate that the fastest way to the destination is to drive five streets to the east where a takeoff is permitted upon the arrival of the dual-mode vehicle, e.g., as compared to a closer location where a takeoff may be permitted in five minutes (e.g., due to road traffic, other dual-mode vehicles having been granted earlier permission to takeoff or land, etc.).

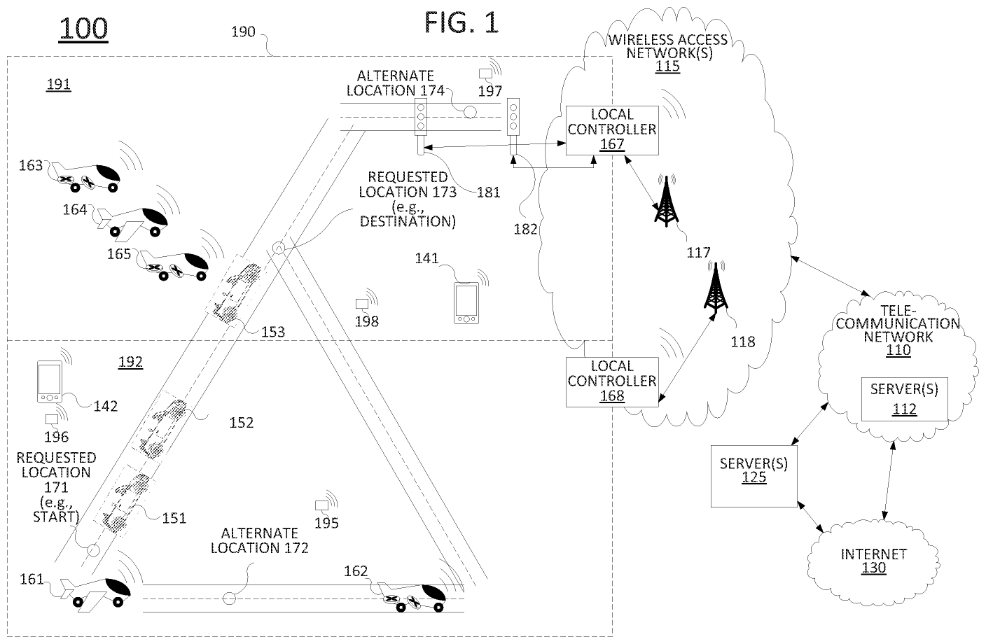

It should be noted that a similar process may be followed with respect to obtaining/granting a permission to land. For instance, an operator may navigate a dual-mode vehicle towards a destination in aerial mode without having a specific permission to land at a requested location. In one example, as the dual-mode vehicle approaches an intended destination, the dual-mode vehicle may communicate the intended destination as a “requested location” to land (e.g., by messaging the local controller assigned to an area including the destination). In such case, the local controller may apply the same or similar factors as discussed above, e.g., weather conditions, aerial and surface-based traffic, time of day, day of week, or other restrictions, fuel level, engine status, and so forth, the determine whether to permit or deny the landing at the requested location (e.g., the destination as indicated in the navigation plan). Again, in the case that the transition is not permitted at the requested location, the local controller may determine an alternate location where the transition (landing) may be permitted. In each case, whether permission is granted for the requested location or an alternate location is offered, the local controller may request that the dual-mode vehicle provide confirmation (e.g., acceptance or denial) of the permission and/or offer. In one example, the local controller may report detail regarding requests, landings/take-offs, and so forth to the policy manager for fee logging, compliance management, and so forth. These and other aspects of the present disclosure are discussed in greater detail below in connection with the examples of FIGS. 1-3.

To aid in understanding the present disclosure, FIG. 1 illustrates an example system 100, related to the present disclosure. As shown in FIG. 1, the system 100 connects mobile devices 141 and 142, server(s) 112, server(s) 125, surface vehicles 151-153, dual-mode vehicles 161-165, sensor units 195-198, local controllers 167 and 168, and so forth with one another and with various other devices via a core network, e.g., a telecommunication network 110, a wireless access network 115 (e.g., a cellular network), and Internet 130.

In one example, the system 100 includes a telecommunication network 110. In one example, telecommunication network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the telecommunication network 110 uses a network function virtualization infrastructure (NFVI), e.g., host devices or servers that are available as host devices to host virtual machines comprising virtual network functions (VNFs). In other words, at least a portion of the telecommunication network 110 may incorporate software-defined network (SDN) components.

In one example, one or more wireless access networks 115 may each comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network(s) 115 may each comprise an access network in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 may each comprise a Node B, evolved Node B (eNodeB), or gNodeB (gNB), or any combination thereof providing a multi-generational/multi-technology-capable base station.

In the present example, wireless access network(s) 115 may include local controllers (LCs) 167 and 168. In addition, as illustrated in FIG. 1, local controllers 167 and 168 may be assigned to areas 191 and 192, respectively, in region 190. In one example, each of the local controllers 167 and 168 may be associated with a respective base station 117 and 118 (e.g., a gNB). In such an example, local controllers 167 and 168 may communicate with dual-mode vehicles 161-165 via the respective base stations 117 and 118. In one example, local controllers 167 and 168 may also obtain information from sensor units 195-198, surface vehicles 151-153, mobile devices 141 and 142, and so forth, via base stations 117 and 118.

In the present example, mobile devices 141 and 143, dual-mode vehicles 161-165, surface vehicles 151-153, and/or sensor units 195-198 may be in communication with base stations 117 and 118, which provide connectivity between dual-mode vehicles 161-165, surface vehicles 151-153, mobile devices 141 and 142, and other endpoint devices within the system 100, various network-based devices, such as local controllers 167 and 168, server(s) 112, server(s) 125, and so forth. In one example, wireless access network(s) 115 may be operated by the same service provider that is operating telecommunication network 110, or one or more other service providers.

In another example, each of local controllers 167 and 168 may comprise a base station for cellular and/or non-cellular wireless communication (e.g., a picocell, femtocell, or the like). For instance, local controllers 167 and 168 may be equipped with antenna and radio infrastructures such as multiple input multiple output (MIMO) antennas, and millimeter wave antennas. In this regard, the footprint or coverage area of local controllers 167 and 168, may in some instances be smaller than the coverage provided by NodeBs or eNodeBs of 3G-4G RAN infrastructure. For example, the coverage of local controllers 167 and 168 utilizing one or more millimeter wave antennas may be 1000 feet or less. In such an example, local controllers 167 and 168 may have direct wireless (e.g., cellular and/or non-cellular wireless) communications with dual-mode vehicles 161-165 (and in various examples, surface vehicles 151-153, mobile devices 141 and 142, and/or sensor units 195-198 as well). As noted above, local controllers 167 and 168 may be in communication with and may be configured to send instructions to and/or otherwise control traffic signals in an assigned area. Thus, for instance, in the example of FIG. 1, local controller 167 may be in communication with traffic signals 181 and 182. In various examples, the connections between local controller 167 and traffic signals 181 and 182 may comprise wired and/or wireless links. For example, traffic signals 181 and 182 may be part of a traffic management system for both surface and aerial vehicular traffic that includes at least area 191, and that includes local controller 167.

As illustrated in FIG. 1, each of the mobile devices 141 and 142 may comprise, for example, a cellular telephone, a smartphone, a tablet computing device, a laptop computer, a wireless enabled wristwatch, or any other wireless and/or cellular-capable mobile telephony and computing devices (broadly, a “mobile device” or “mobile endpoint device”). In one example, mobile devices 141 and 142 may be equipped for cellular and non-cellular wireless communication. For instance, mobile devices 141 and 142 may include components which support peer-to-peer and/or short range wireless communications. Thus, each of the mobile devices 141 and 142 may include one or more radio frequency (RF) transceivers, e.g., for cellular communications and/or for non-cellular wireless communications, such as for IEEE 802.11 based communications (e.g., Wi-Fi, Wi-Fi Direct), IEEE 802.15 based communications (e.g., Bluetooth, Bluetooth Low Energy (BLE), and/or ZigBee communications), and so forth.

Sensor units 195-198 may comprise, for example, temperature sensors, wind sensors, roadway monitoring sensors (or traffic sensors), and so forth, as well as computing and communication resources. For instance, sensor units 195-198 may include one or more radio frequency (RF) transceivers, e.g., for cellular communications and/or for non-cellular wireless communications, such as for IEEE 802.11 based communications (e.g., Wi-Fi, Wi-Fi Direct), IEEE 802.15 based communications (e.g., Bluetooth, Bluetooth Low Energy (BLE), and/or ZigBee communications), low power wide area (LPWA) cellular communications, such as Narrowband Internet of Things (NB-IoT) communications, Long Term Evolution-Machine Type Communications (LTE-M), and so forth. In one example, sensor units 195-198 may be configured to detect dual-mode vehicles and/or surface vehicles within a vicinity, e.g., via wireless peer sensing, such as via a wireless peer discovery message (e.g., a Wi-Fi Direct peer discovery message transmitted by either one of the sensor units 195-198, or one of the dual-mode vehicles 161-165 or surface vehicles 151-153 that is being detected). In one example, sensor units 195-198 may be configured as wireless access beacons that may be coordinated by local controllers 167 and 168. For instance, local controllers 167 and 168 may individually or collectively manage one or more of sensor units 195-198 as a wireless mesh network, with each of sensor units 195-198 operating as a wireless access point for communications with dual-mode vehicles 161-165 and surface vehicles 151-153.

Dual-mode vehicles 161-165 may each comprise a vehicle that is equipped to operate as a conventional surface-operating vehicle and an aerial operating vehicle, and to comply with and follow all relevant laws and regulations regarding surface-based vehicular operation on road, highways, or other rights-of-way within region 190, as well as all relevant laws and regulations regarding aerial vehicular operation within region 190. In the example of FIG. 1, dual-mode vehicles 161 and 164 may have forward-take-off-and-landing (FTOL) configurations, while dual-mode vehicles 162, 163, and 165 may have vertical-take-off-and-landing (VTOL) configurations. As noted above, each of dual-mode vehicles 161-165 may be equipped for cellular and/or non-cellular wireless communications with local controllers 167 and 168, base stations 117 and 118, sensor units 195-198, other ones of dual-mode vehicles 161-165 or surface vehicles 151-153 via peer-to-peer communications, and so forth. In addition, each of dual-mode vehicles 161-165 may include a computing device or processing system comprising at least a navigation system (such as a Global Positioning System (GPS) navigation unit) via which an operator may enter a destination, obtain navigation path recommendations to reach the destination, and so forth. In one example, each of dual-mode vehicles 161-165 may also include automated and/or operator assist functionality, such as for surface-based operations: lane sensing/lane maintenance capability and/or lane departure warning, following distance capability, automatic braking and/or crash avoidance capability, and so forth. Similarly, for aerial mode operations, the automated and/or operator assist functionality may include: flight path maintenance, speed maintenance, heading/bearing maintenance, yaw, pitch, and/or roll maintenance, altitude maintenance, etc., warnings for any one or more of the above (e.g., a low altitude warning, an altitude change warning, a stall warning, etc.).

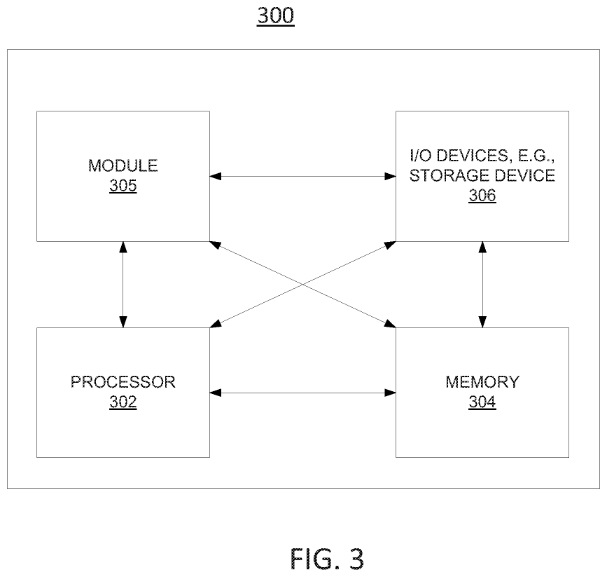

As shown in FIG. 1, telecommunication network 110 may also include one or more servers 112. In one example, each of the server(s) 112 may comprise a computing device or processing system, such as computing system 300 depicted in FIG. 3 and may be configured to provide one or more functions in connection with examples of the present disclosure for identifying an alternate location at which a requested transition between operational modes of a dual-mode vehicle is permitted. For example, one or more of the server(s) 112 may be configured to perform one or more steps, functions, or operations of a policy manager as described herein. For instance, server(s) 112 may collect, store, and process data regarding capabilities of dual-mode vehicles 161-165, such as top speed, fuel capacity, turn radius, stall speed, etc. In one example, server(s) 112 may coordinate among local controllers (e.g., including local controllers 167 and 168), may assign areas to local controllers, e.g., areas 191 and 192, respectively, in region 190, may designate local controllers for backup/failover purposes, and so forth. In one example, server(s) 112 may obtain, store, and disseminate to local controllers 167 and 168 various parameters or constraints relating to mode transitions for dual-mode vehicles (e.g., policies/configuration parameters based upon laws, rules, regulations, etc., as obtained by the server(s) 112). Server(s) 112 may also obtain, store, and disseminate to local controllers 167 and 168 other information in connection with examples of the present disclosure for identifying an alternate location at which a requested transition between operational modes of a dual-mode vehicle is permitted. Such information may include, for instance, geographic data (e.g., map data, such as roadway information, topology information, etc.), traffic data (e.g., road traffic data), pedestrian density data (e.g., from tracking mobile device locations, such as mobile devices 141 and 142), operator licensing and/or skill level data, dual-mode vehicle performance and/or capability data, and so forth.

In one example, dual-mode vehicles 161-165 may be operated as endpoint devices/user equipment (UE) of the telecommunication network 110. Thus, in one example, server(s) 112 may track connectivity information of dual-mode vehicles 161-165, location information of dual-mode vehicles 161-165, and so forth. In one example, one or more of the surface vehicles 151-153 may similarly be operated as endpoint devices/user equipment (UE) of the telecommunication network 110, and may be tracked and managed accordingly. Thus, in one example, server(s) 112 may also provide to local controllers 167 and 168 location information regarding dual-mode vehicles 161-165 and/or surface vehicles 151-153 (e.g., for those dual-mode vehicles that may not be in direct or local communication with local controller 167 or local controller 168, respectively). For ease of illustration, various additional elements of telecommunication network 110 are omitted from FIG. 1. It should also be noted that although local controllers 167 and 168 are described as obtaining various information from server(s) 112, in other, further, and different examples, local controllers 167 and 168 may obtain the same or similar information directly from dual-mode vehicles 161-165, surface vehicles 151-153, mobile devices 141 and 142, etc., or locally from such entities (e.g., via one or more of base stations 117 and 118, without such information flowing from these entities through server(s) 112). Similarly, local controllers 167 and 168 may communicate with each other via peer-to-peer connections to exchange various information regarding road and/or aerial traffic, specific vehicle locations, weather conditions, and so forth. In such case, local controllers 167 and 168 may communicate wirelessly or via terrestrial links (e.g., one or more optical links coupling the base stations 117 and 118, local controllers 167 and 168, and other equipment of wireless access network(s) 115 with each other, with telecommunication network 110, etc.).

As further illustrated in FIG. 1, the system 100 includes server(s) 125. In one example, server(s) 125 may include a weather data server (WDS). In such an example, weather data may be obtained by server(s) 112 and/or local controllers 167 and 168 from server(s) 125 via a weather service data feed, e.g., a National Weather Service (NWS) extensible markup language (XML) data feed, private or home weather stations, or the like. In another example, the weather data may be obtained by retrieving the weather data from the WDS. It should be noted that in one example, local controllers 167 and 168, server(s) 112, and/or server(s) 125 may receive and store weather data from multiple parties. For instance, in one example, local controllers 167 and 168 may obtain weather data from sensors units 195-198.

In addition, in one example, server(s) 125 may include a geographic information system (GIS). For instance, server(s) 125 may also store and provide one or more road map databases, such as the United States Geological Survey (USGS) National Transportation Dataset (NTD), ArcGIS, HERE map database, and so forth. In one example, such databases may include or comprise a digital elevation model (DEM), which may comprise a set of raster files or other format files, that records elevations for a set of given points (latitude, longitude). Alternatively, or in addition, server(s) 125 may provide one or more separate digital elevation models that may be combined with road map database(s). For instance, the digital elevation model may comprise Shuttle Radar Topography Mission (SRTM) data, which may provide measurements of elevation (e.g., relative to mean sea level (MSL)) in 1 arc-second, 30 meter resolution. In one example, the digital elevation model may be maintained by a commercial provider, such as Forsk Atoll, and so forth. In one example, server(s) 125 may provide traffic data (e.g., road traffic) data in addition to other geographic information. For instance, one or more of server(s) 125 may alternatively or additionally provide a traffic data service.

Accordingly, in one example, server(s) 112 may obtain, utilize, and/or store geographic, traffic, and/or topology information (e.g., for region 190) from server(s) 125. In one example, server(s) 112 may combine or overlay geographic, traffic, and/or topology information from multiple sources (e.g., from any of server(s) 125, from local controllers 167 and 168, from sensor units 195-198, from mobile devices 141 and 142, and so forth).

In one example, the local controllers 167 and 168 may each comprise a computing device or processing system, such as computing system 300 depicted in FIG. 3, and may be configured to perform various steps, functions, and/or operations for identifying an alternate location at which a requested transition between operational modes of a dual-mode vehicle is permitted, as described herein. For example, local controllers 167 and 168 may each be configured to perform one or more steps, functions, or operations in connection with the example method 200 described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 3 and discussed below) or multiple computing devices collectively configured to perform various steps, functions, and/or operations in accordance with the present disclosure.

To illustrate, as shown in FIG. 1, a user operating dual-mode vehicle 161 (or “operator”) may be at home and may be planning to travel to work at a different location. The operator may start the dual-mode vehicle 161 and may enter the intended destination location (e.g., the user's work location, which in the present example, may comprise requested location 173) into a navigation system of the dual-mode vehicle 161. In one example, the user may also enter a desired location to transition from a surface operation mode to an aerial operation mode (e.g., requested location 171, or the requested “start” location of an aerial leg of the trip). In another example, the requested location 171 may be automatically determined by the navigation system of dual-mode vehicle 161. For instance, the requested location 171 may be implied to be the current location, or a closest location of a public road/right-of-way. For example, the aerial mode of operation may be preferred to the extent possible due to the ability to more quickly cover a greater distance and avoid traffic. Thus, if the dual-mode vehicle 161 is in the driveway of the user's home, the user may indicate this location, or a location on the street immediately at the end of the driveway, etc. for the requested location 171, or the requested location 171 may be determined automatically by the dual-mode vehicle 161.

Since the dual-mode vehicle 161 is located in area 192, the dual-mode vehicle 161 (e.g., via the navigation system thereof) may submit a navigation plan/request to the local controller 168 that is assigned to the area 192. The request may include, at a minimum, either the intended destination location, a request to transition to aerial mode (e.g., without a particular destination) and/or a request to transition to aerial mode at the requested start location 171. In one example, the local controller 168 may determine the requested location 171, based upon a current location of dual-mode vehicle 161, if the requested location is not included within or along with the request from the dual-mode vehicle 161 (e.g., as the current location of the dual-mode vehicle 161 or a closest location of a public road/right-of-way). The current location of the dual-mode vehicle 161 may be included in the request by the dual-mode vehicle 161, or may be determined by the local controller 168, e.g., via observed time difference of arrival (OTDA), barycentric triangulation, or a similar technique with reference to one or more of sensor units 195-198, base stations 117-118, etc., or from the server(s) 112, which may determine and/or store such location information as calculated in the same or similar manner, or as reported by dual-mode vehicle 161 to server(s) 112, and so forth.

The local controller 168 may be primarily tasked with determining whether the transition to aerial mode is permitted at the requested location 171. In accordance with the present disclosure, the determination may be based upon several factors, including: geographical conditions (e.g., topology or other aspects), road conditions, which may be determined from sensors and vehicles at or near the requested location 171 in communication with and accessible to the local controller 168 (e.g., rain, ice, traffic density, traffic speed, etc.), weather conditions, which may similarly be determined from sensor units (such as sensor unit 196) and vehicles (such as surface vehicles 151 and 152) in communication with the local controller 168, time of the day, day of the week, time of year, etc. (for instance, 8:00 AM take-off may be allowed on weekdays but not on weekends), operator qualifications, capabilities of dual-mode vehicle 161, any fees associated with landing and/or taking-off, such as determined by governmental or regulatory authorities, and so on.

The local controller 168 may determine that the takeoff at the requested location 171 is not available based upon any one of the above or other factors. For instance, with respect to topology information, the requested location 171 may be determined by local controller 168 to be on a steep slope (e.g., from topology gradient information obtained from a geographic information system (GIS), such as digital elevation model (DEM)). Since the dual-mode vehicle 161 is a FTOL type vehicle, the requested location 171 is therefore not an acceptable location. As such, even if other factors are determined to be acceptable for the requested location 171, the local controller 168 may nevertheless determine that the requested transition to aerial mode is not permitted at the requested location 171.

In another example, the slope/gradient of a road, the maximum straight run of road, or other aspects at the requested location 171 may be such that operators of a particular licensed skill level operating a dual-mode vehicle having certain minimum capabilities may be permitted to take-off, but that other operators with lesser skill levels or less-capable dual-mode vehicles (such as those requiring longer take-off runs) are not. Thus, in one example, the local controller 168 may look-up and cross-reference the user's skill level and/or the capabilities of dual-mode vehicle 161 with the determined slope/gradient, available straight run, etc. to determine whether the requested transition to aerial mode at the requested location 171 is permitted for this particular user in this particular dual-mode vehicle 161.

Alternatively, or in addition, the local controller 168 may determine whether there is an acceptable level of traffic at or near the requested location 171 in order to permit the requested transition to aerial mode. For instance, via direct and/or local communications, and/or from traffic data obtained from server(s) 112 and/or server(s) 125, the local controller 168 may determine that there is currently a high traffic condition at the requested location 171. For instance, as illustrated in FIG. 1, there are surface vehicles 151 and 152 close to the requested location 171. In accordance with the present disclosure, the acceptable level of traffic may be configured for various locations as determined by an operator of local controllers 167 and 168. Continuing with the present example, local controller 168 may determine that the current traffic condition at requested location 171 is not acceptable to permit the requested transition.

In one example, local controller 168 may also determine whether the requested transition may be permitted at the requested location within one or more time periods from the time the request is submitted, e.g., within the next five minutes, the next ten minutes, etc. For instance, the local controller 168 may determine whether the traffic condition is anticipated to change during the time period so as to permit the requested transition to aerial mode at the requested location 171 at a later time. For instance, the anticipated traffic condition may be obtained from server(s) 112 and/or server(s) 125, e.g., a traffic data service provided by the telecommunication network 110 and/or a third-party service, etc. In one example, the local controller 168 may include a machine learning (ML) module that learns traffic patterns within area 192 such that local controller 168 may make traffic predictions based upon historical traffic data. For instance, as described above, local controller 168 may communicate with and track movements of surface vehicles and dual-mode vehicles within area 192. Local controller 168 may consider current conditions as well as predicted conditions within the time period(s) for other factors, such as weather data, pedestrian traffic or presence, governmental restrictions that may be scheduled to take effect or that may be released (such as an upcoming 10:00 PM curfew), and so forth. For instance, the local controller 168 may calculate/predict or otherwise determine that after 10 minutes, the traffic level will decrease to an acceptable level. However, the local controller 168 may also determine that there is bad weather approaching that will cause the weather condition(s) for the requested transition to not be met. As such, the local controller 168 may determine that the requested transition to aerial mode at the requested location 171 is not permitted at the current time or at any time within the time period(s) for which the local controller 168 has looked ahead. Thus, the requested transition at the requested location 171 may be denied.

In each case, the local controller 168 may determine the acceptability of various factors (or the failure/non-compliance of various factors) via calculations at the local controller 168 itself, or may submit a request to server(s) 112 to verify one or more aspects of the request from dual-mode vehicle 161 (such as the geography/topology, weather, operator qualifications, etc.). For illustrative purposes, the local controller 168 may determine that the requested transition at the requested location 171 is not permitted (either at the current time and/or within one or more future time periods). However, in accordance with the present disclosure, the local controller 168 may also determine whether one or more alternate locations are available where the requested transition would be permitted (e.g., at the current time or within one or more future time periods).

In such case, the local controller 168 may determine alternate location(s) within the area 192 to which it is assigned, or may determine alternate location(s) in one or more nearby areas that is/are assigned to another local controller, or controllers (such as local controller 167 in area 191). In the latter case, the local controller 168 may communicate and coordinate with the local controller 167 to confirm the availability of one or more alternate locations, and to indicate that the requested transition is permitted at such alternate location(s), the time periods for which the transition is permitted (if applicable), and so forth. The availability of such alternate locations, e.g., whether the requested transition is permitted at such alternate locations, may be evaluated in the same or similar manner as described above with respect to the requested location 171. In one example, the local controller 168 may begin evaluating alternate locations via an algorithm that progressively evaluates locations closest and then progressively further from the requested location 171. However, in one example, the algorithm may first evaluate locations that are more than a certain distance from the requested location 171, e.g., at least one street away, at least two blocks away, at least a quarter mile away, at least one mile away, etc. For instance, depending upon the factor(s) and/or condition(s) that cause the requested transition to be not permitted at the requested location 171, it may be assumed that the same factor(s) and/or condition(s) are likely to render other nearby locations unsuitable for the same reasons (e.g., bad weather on the user's home street is likely to be similar within at least a half-mile radius, a one mile radius, etc.). Similarly, it may be considered that neighborhood traffic conditions may be similar, such that the local controller 168 may first consider candidate locations at least three blocks away, a quarter mile away, etc. In one example, the algorithm may proceed until at least one alternate location is found where the requested transition is permitted (currently and/or within one or more future time periods). Alternatively, or in addition, the algorithm may proceed for a maximum time period, a maximum number of calculations, and/or until a maximum search area has been exhausted.

As illustrated in FIG. 1, the local controller 168 may determine that the requested transition is permitted at least one alternate location, e.g., alternate location 172. For instance, alternate location 172 may be determined to be relatively flat (e.g., for dual-mode vehicle 161 being a FTOL type vehicle), may be traffic free and/or have relatively low traffic (e.g., low surface traffic, or both low surface traffic and low aerial traffic), may have clear weather and/or may be anticipated to have clear weather throughout a future time period (e.g., the next 20 minutes, for which the suitability of alternate location 172 may have been evaluated, etc.), may have no pedestrian presence, may have no governmental restrictions, and so forth. For instance, local controller 168 may determine or may be tracking the location of dual-mode vehicle 162, which may also be known to the local controller 168 to be heading away from alternate location 172. Otherwise, there does not appear to be other surface, aerial, or dual-mode vehicles in the vicinity of alternate location 172. In addition, other factors and/or conditions may be satisfied such that the requested transition is permitted.

In one example, the local controller 168, or the local controller 168 in conjunction with other local controllers (e.g., local controller 167) and/or server(s) 112, may determine from among several options for alternate locations, which may assist the user/operator in reaching the destination at the earliest time. For instance, a routing module of the local controller 168 and/or server(s) 112 may calculate that the fastest way to the destination is to drive to alternate location 172 (e.g., five streets to the east where a takeoff is permitted upon the arrival of the dual-mode vehicle 162), e.g., as compared to a closer location where a takeoff may be permitted after 15 minutes (e.g., due to road traffic, other dual-mode vehicles having been granted earlier permission to takeoff or land, etc.).

Local controllers 167 and 168 may provide responses to each request associated with a transition between operational modes for a dual-mode vehicle. Each response may include a grant or denial of permission to engage in a requested transition at a requested location. In addition, for granted requests, in one example, a time period may be provided for which the permission remains valid (e.g., transition between aerial mode and surface mode is permitted at the requested location for the next 5 minutes, the next 10 minutes, between 8:42 AM and 8:44 AM, etc.). In one example, for a request that is denied, the response may include one or more alternate locations at which the requested transition between modes of operation may be permitted (and the time period(s) for which such permission(s) are valid). It should also be noted that in some cases, even where a request is permitted for a requested location, one or more alternate locations may also be evaluated and provided in the response. For instance, a permission may be granted for a requested transition at a requested location, but the permission may be for a time period starting 15 minutes from a current time and extending to 20 minutes from the current time. Meanwhile, there may be a nearby alternate location at which the requested transition may be permitted for the next five minutes. Thus, the response may include both the requested location (and the permitted time period) as well as one or more alternate locations (along with permitted time period(s) which may be deemed more advantageous, and which may be selected instead of the requested location).

In one example, local controllers 167 and 168 may calculate earliest times to reach intended destinations via one or more of the requested locations or one or more alternate locations, and may provide a recommendation of a particular option for selection by a user of the dual-mode vehicle, or may provide a ranked list of options, or the like. For instance, one of local controllers 167 and 168 may calculate an added surface driving time from a starting location to reach an alternate location for a takeoff request, and add to a calculation of flight time to reach a destination, or may calculate an added driving time from an alternate location to a destination for a landing request, and add to any remaining calculated flight time from a current location to the alternate destination, which may be compared to and/or compiled with similar calculations for routings via other alternate locations. In each case, local controllers 167 and 168 may seek an acceptance, selection, and/or confirmation from a dual-mode vehicle of a grant of permission for a requested transition at a requested location or particular alternate location. As such, the local controllers 167 and 168 may avoid maintaining multiple open slots at various times and locations for dual-mode vehicles which would go unused and which could be assigned/reserved for other dual-mode vehicles.

Returning to the example of the user of dual-mode vehicle 161 traveling to a destination (requested location 173), local controller 168 may determine to deny a request for transitioning to aerial mode at requested location 171, but may determine that the requested transition is permitted at alternate location 172. In such case, local controller 168 may transmit a response to dual-mode vehicle 161 indicating the availability of alternate location 172 (along with a relevant time period, if applicable). The dual-mode vehicle 161 may present the response via a user interface of the dual-mode vehicle 161, via which the user/operator may make a selection (e.g., to accept or deny the offer of alternate location 172). The dual-mode vehicle 161 may then transmit a reply to local controller 168 denying or accepting the offer. Assuming that the offer is accepted. The user may then navigate dual-mode vehicle 161 to alternate location 172 in surface mode (e.g., along one or more roadways), may operate to transition the dual-mode vehicle 161 for aerial mode operations (e.g., by extending wings, disabling certain braking functions, deploying a propeller, etc.), and may then takeoff from the alternate location 172.

In one example, local controller 168 may continue to monitor the location of dual-mode vehicle 161 to confirm that the dual mode-vehicle will arrive at the alternate location 172 within any time period for which the permission remains valid, may communicate with the dual-mode vehicle 161 for final confirmation that the dual-mode vehicle 161 and/or the user/operator thereof is ready to proceed with the transition to aerial mode, to verify that there are no adverse changes in conditions to prevent the takeoff (e.g., unanticipated bad weather, a traffic accident on the roadway, etc.), and so forth. Similarly, in one example, local controller 168 may continue to monitor dual-mode vehicle 161 in-flight, to the extent that local controller 168 is able to do so (e.g., as long as dual-mode vehicle 161 is in communication range of local controller 168, sensor units 195 and/or 196, etc.). In one example, local controller 168 may notify server(s) 112) and/or other local controllers along an anticipated route of the dual-mode vehicle 161 so that such other local controllers may anticipate the dual-mode vehicle 161 becoming part of the traffic volume in an area assigned to a different local controller, the possibility that dual-mode vehicle 161 may seek a landing in such other area, and so forth. For instance, local controller 167 may be notified by local controller 168, or by local controller 168 via server(s) 112 that the dual-mode vehicle 161 is on route to the intended destination (e.g., requested location 173).

It should be noted that in accordance with the present disclosure, the user/operator of dual-mode vehicle 161 may begin navigating toward the destination without waiting for a response from local controller 168, without obtaining a permission for a requested location or any alternate locations, without accepting any offer for a requested location or alternate location that is provided by the local controller 168, and so forth. In particular, since the dual-mode vehicle 161 is already in surface mode operation and does not need any specific permission to begin driving on the roads, the user may simply commence the trip. At some later time, such as after driving for 10 minutes towards the destination, the user may then submit a request to transition to aerial mode, where the requested location for the transition is somewhere else that may be closer to the destination. Thus, the user does not need to wait for a takeoff location or time that is near the starting location, does not need to accept any offers that the user does not prefer, and so forth. The flexibility remains for the user to commence a journey as the user sees fit, subject to the contrasts that may be applied by local controller 168 regarding the ability of the dual-mode vehicle 161 to transition to aerial mode within the region 192.

The foregoing illustrates an example of local controller 168 managing a requested transition to aerial mode from surface mode for dual-mode vehicle 161. To further demonstrate aspects of the present disclosure relating to transitions from aerial mode to surface mode, it is noted that FIG. 1 illustrates the intended destination of dual-mode vehicle 161 as the requested location 173. In one example, the requested location 173 may be implicit in a navigation request. For instance, if the user enters into the navigation system of dual-mode vehicle 161 the destination of “work,” the navigation system may determine that the requested location 173 for a transition from aerial mode back to surface mode (e.g., a landing) is at a parking lot for the work location, a closest point on a road next to the work location, etc. In one example, the requested location 173 may be included in an initial plan/request that may be provided by dual-mode vehicle 161 to local controller 168, which may be forwarded to local controller 167. In another example, the dual-mode vehicle 161 may come into communication with local controller 167 (e.g., as the dual-mode vehicle 161 may enter or approach area 191, as the dual-mode vehicle 161 comes within communication range of local controller 167, base station 117, sensor unis 197 or 198, etc.) and may convey the requested location 173 as an intended destination (e.g., a preferred/requested location the transition from aerial mode to surface mode).

In one example, the dual-mode vehicle 161 may provide to the local controller 167 a requested time for the transition (e.g., an anticipated arrival time, or an otherwise requested or preferred time to engage in the transition to surface mode operation (e.g., a landing)). In another example, the local controller 167 may calculate a time to reach the requested location 173, e.g., based upon a currently tracked location of the dual-mode vehicle 161, a current flight speed, etc. The local controller 167 may then evaluate whether the requested transition to surface mode is to be permitted for the requested location 173 at the requested and/or anticipated time based upon a plurality of factors and/or criteria. For instance the factors or criteria may be the same as or similar to those discussed above in connection with the requested transition for dual-mode device 161 from surface mode to aerial mode at the requested location 171. This may include geographical conditions (e.g., topology or other aspects), road conditions, which may be determined from sensors and vehicles at or near the requested location 173 in communication with and accessible to the local controller 167 (e.g., rain, ice, traffic density, traffic speed, etc.), weather conditions, which may similarly be determined from sensor units (such as sensor unit 198) and vehicles (such as surface vehicle 153) in communication with the local controller 167, time of the day, day of the week, time of year, etc. (for instance, landings prior to 9:00 AM may be allowed on weekdays but not on weekends), operator qualifications, capabilities of dual-mode device 161, any fees associated with landing and/or taking-off, such as determined by governmental or regulatory authorities, and so on.

Similar to the above description relating to local controller 168, local controller 167 may evaluate the requested location 173 for the requested transition with regard to one or more time periods (e.g., after an anticipated and/or otherwise requested time). In addition, local controller 167 may evaluate one or more alternate locations for the requested transition (which may include evaluations over one or more time periods for which the requested transition may be permitted at such alternate locations). Local controller 167 may further evaluate anticipated earliest times that the dual-mode vehicle may arrive at the destination (which could be requested location 173, or a nearby location) via transitions at the one or more alternate locations, e.g., including any additional time to reconfigure the dual-mode vehicle 161 for surface mode operations and to drive from the alternate locations to the desired destination. Also similar to the discussion above, in various examples, local controller 167 may provide a response that may indicate that the requested transition (e.g., landing) is or is not permitted at the requested location 173. When the permission is granted, the response may include time period(s) at which the requested transition may be allowed at the requested location 173 (e.g., either at a requested and/or anticipated time, or for some other time period for which the dual-mode device 161 may need to wait at or near the requested location 173 before commencing the landing (e.g., by hovering, maintaining a holding pattern, etc.)).

Regardless of whether or not the request is permitted or denied, the response may include one or more alternate locations at which the requested transition is permitted, and in one example, may also indicate one or more time periods over which such permissions may be valid (e.g., within 15 minutes of a preferred, anticipated, or requested landing at the originally requested location 173). In one example, the response may comprise an offer and may seek an acceptance, confirmation, or explicit rejection of any or all offers for the requested transition at the requested location 173 and/or one or more alternate locations. In one example, the offer(s) may be valid for some period of time that is shorter than the validity time period(s) indicated in the response. For instance, the dual-mode device 161 and/or the user/operator thereof may have to accept one of the offers within one minute; otherwise, all of the offers may expire. As such, resources of time and space may be reallocated to other dual-mode vehicles, or may remain in full use by surface operating vehicles for moving the greatest volume of traffic, etc.

In the present example, and as illustrated in FIG. 1, there may be a high traffic condition at the requested location 173. For instance, surface vehicle 153 as well as other dual-mode vehicles 163-163 are all approaching the requested location 173. In such case, local controller 167 may determine that the requested landing by dual-mode vehicle 161 should not be permitted at requested location 173 (or at least should not be permitted within a relevant time period, e.g., within the next 20 minutes). However, local controller 167 may also determine that alternate location 174 is available, that a landing is permitted there within the next five minutes, and that the dual-mode vehicle 161 is capable of arriving within such time period (e.g., it may be calculated that the dual-mode vehicle 161 may reach the alternate location 174 within two minutes flight time at a current speed and/or within a reasonable speed within the capabilities of dual-mode vehicle 161 and the skill level of the user). Thus, a response from local controller 167 to dual-mode vehicle 161 may indicate at least the availability of alternate location 174 (and a time period for which the transition to surface mode operation is permitted), and may further include a time period for acceptance of the offer.

The dual-mode vehicle 161, or the user thereof via a user interface, may accept the offer and convey a reply to the local controller 167 with the acceptance of the offer. The local controller 167 may then continue to track and monitor dual-mode vehicle 161 in-flight to confirm that the dual-mode vehicle 161 will arrive at the alternate location 174 within any time period for which the permission remains valid, may communicate with the dual-mode vehicle 161 for final confirmation that the dual-mode vehicle 161 and/or the user/operator thereof is ready to proceed with the transition to surface mode, to verify that there are no adverse changes in conditions to prevent the landing (e.g., unanticipated bad weather, a traffic accident on the roadway, etc.), and so forth.

As further illustrated in FIG. 1, the local controller 167 may be in communication with and may control or instruct traffic signals 181 and 182. In the present example, the local controller 167 may coordinate these traffic signals 181 and 182 in connection with the landing of dual-mode vehicle 161. For instance, when the dual-mode vehicle 161 is confirmed to be present and ready to land at the alternate location 174, as a mandatory or at least a precautionary measure, the local controller 167 may cause surface traffic to be halted along a roadway in the vicinity of alternate location 174. Thus, the landing may be made clear for dual-mode vehicle 161. It should also be noted that various locations may have different designations for requirements relating to control of traffic signals. For instance, in one location it may be mandatory that traffic signals be available and be used in connection with dual-mode vehicles transitioning between modes of operation. However, in another location, control of traffic signals may be unavailable and/or may be optional.

In addition, in one example, a requirement and/or option to control traffic signals may be taken into account in determining whether an alternate location is available, whether the alternate location is better than the requested location and/or one or more other alternate locations, and so forth. For instance, the local controller 167 may penalize the ranking of alternate location 174, e.g., as compared to other alternate locations, due to a requirement to utilize traffic signals 181 and 182 to halt surface traffic. Nevertheless, in the present example, it may be assumed that no other alternate location was determined to be available (or that no other alternate location that was found was determined to be superior to alternate location 174).

After landing at alternate location 174, the dual-mode vehicle 161 may be transitioned to surface mode configuration, and may be navigated over one or more roadways to the destination. Notably, the dual-mode vehicle 161 may arrive earlier at the destination than if the dual-mode vehicle were to wait for a landing at the requested location 173.

It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to local controllers 167 and 168 may alternatively or additionally be performed by server(s) 112 and/or server(s) 125, and vice versa. In addition, although server(s) 112 and 125 are illustrated in the example of FIG. 1, in other, further, and different examples, the same or similar functions may be distributed among multiple other devices and/or systems within the telecommunication network 110, wireless access network(s) 115, and/or the system 100 in general that may collectively provide various services in connection with examples of the present disclosure for identifying an alternate location at which a requested transition between operational modes of a dual-mode vehicle is permitted. Additionally, devices that are illustrated and/or described as using one form of communication (such as a cellular or non-cellular wireless communications, wired communications, etc.) may alternatively or additionally utilize one or more other forms of communication. For instance, sensor units 195-198 may alternatively or additionally be equipped for wired/terrestrial-based communications. Thus, these and other modifications are all contemplated within the scope of the present disclosure.

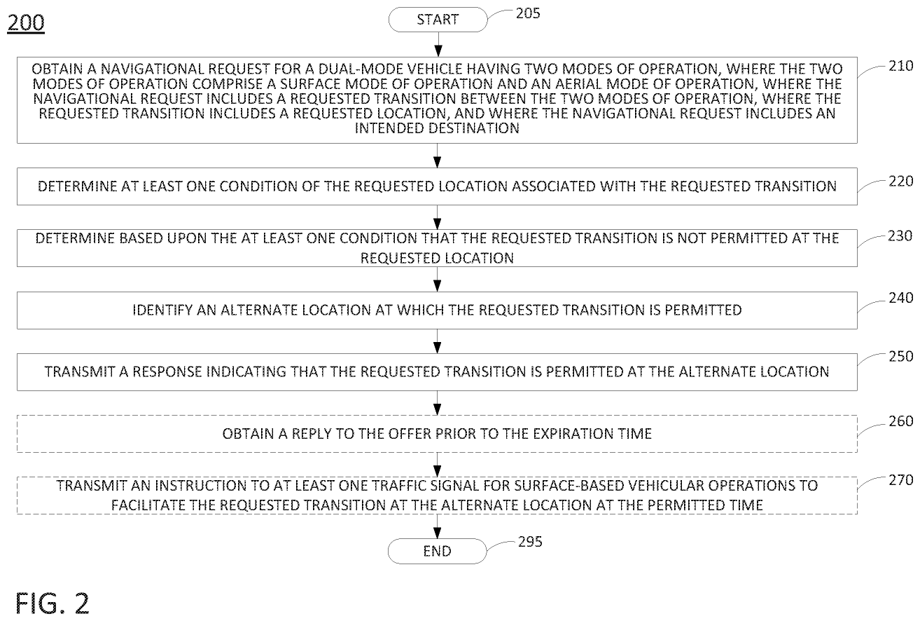

FIG. 2 illustrates a flowchart of an example method 200 for identifying an alternate location at which a requested transition between operational modes of a dual-mode vehicle is permitted. In one example, steps, functions and/or operations of the method 200 may be performed by a device and/or processing system as illustrated in FIG. 1, e.g., by one of local controllers 167 or 168, or any one or more components thereof, or by local controllers 167 or 168 and/or any one or more components thereof in conjunction with one or more other components of the system 100, such as a different one of local controllers 167 or 168, one or more of server(s) 112, or more of server(s) 125, elements of wireless access network 115, telecommunication network 110, any one or more of mobile devices 141 or 142, sensor units 195-198, traffic signals 181 or 182, and so forth. In one example, the steps, functions, or operations of method 200 may be performed by a computing device or processing system, such as computing system 300 and/or hardware processor element 302 as described in connection with FIG. 3 below. For instance, the computing system 300 may represent any one or more components of the system 100 that is/are configured to perform the steps, functions and/or operations of the method 200. Similarly, in one example, the steps, functions, or operations of the method 200 may be performed by a processing system comprising one or more computing devices collectively configured to perform various steps, functions, and/or operations of the method 200. For instance, multiple instances of the computing system 300 may collectively function as a processing system. For illustrative purposes, the method 200 is described in greater detail below in connection with an example performed by a processing system. The method 200 begins in step 205 and proceeds to step 210.

At step 210, the processing system obtains a navigational request for a dual-mode vehicle having two modes of operation, where the two modes of operation comprise a surface mode of operation and an aerial mode of operation. The navigational request may include a requested transition between the two modes of operation, where the requested transition includes a requested location, and where the navigational request includes an intended destination. In one example, the requested transition may be a transition from the surface mode of operation to the aerial mode of operation. In another example, the requested transition may be a transition from the aerial mode of operation to the surface mode of operation.

It should be noted that the navigational request may be sent by the dual-mode vehicle and/or may be received by the processing system prior to the dual-mode vehicle commencing navigation. However, in one example, the navigational request may be sent by the dual-mode vehicle and/or may be received by the processing system after the dual-mode vehicle has commenced navigation in either mode of operation. For instance, the dual-mode vehicle may be requesting to transition to an aerial mode of operation while already driving along a roadway heading toward the destination. Similarly, the dual-mode vehicle may already be in the air heading toward the destination when the processing system obtains a navigational request (e.g., to transition to surface mode operation, or land). In one example, the navigational request may include the current location (e.g., a last measured or recently measured location of the dual-mode vehicle). In another example, the processing system may determine the location of the dual-mode vehicle from one or more other sources of information (e.g., via telecommunication network-based endpoint device location tracking, from triangulation techniques with respect to one or more base stations or other devices in an area, and so forth).

At step 220, the processing system determines at least one condition of the requested location associated with the requested transition. For instance, the at least one condition of the requested location may comprise at least one of: a surface-based vehicular traffic condition, an aerial vehicular traffic condition, a weather condition, a temporal restriction, a governmental restriction, and so forth. In addition, the at least one condition may be determined from at least one of: a sensor that is deployed at the requested location, a camera that is deployed at the requested location, a different dual-mode vehicle at the requested location, a surface-based vehicle at the requested location, a radar, a notification from an authoritative entity (e.g., a governmental entity, a quasi-governmental entity, a private designee of a regulatory authority, etc.), and so forth.

At step 230, the processing system determines, based upon the at least one condition, that the requested transition is not permitted at the requested location. For instance, the processing system may determine that the slope/gradient of a road, the maximum straight run of road, or other aspects at the requested location may fail a condition for permitting the requested transition, may fail a condition for the requested transition in view of a skill level of an operator of the dual-mode vehicle and or the capabilities of the dual-mode vehicle, etc. Alternatively, or in addition, the processing system may determine whether there is an unacceptable level of traffic at or near the requested location in order to permit the requested transition (where the “unacceptable level” may be different for different roads, different road conditions, different jurisdictions, and so forth), an unacceptable weather condition (e.g., rain, wind in excess of a certain speed, fog, etc.), any governmental or other restrictions that may be in effect for the requested location, and so forth. In one example, a failure with respect to any one or more conditions may cause the processing system to determine that the requested transition is not permitted at the requested location.

In one example, the processing system may also determine whether the requested transition may be permitted at the requested location within one or more time periods from the time the request is submitted, e.g., within the next five minutes, the next ten minutes, etc. For instance, the processing system may determine whether the traffic condition is anticipated to change during the time period so as to permit the requested transition at a later time (e.g., up to a maximum time period for which consideration may be given). However, in the present example, it may nevertheless be determined that the requested transition is not permitted at the requested location for any time period that is considered.

At step 240, the processing system identifies an alternate location at which the requested transition is permitted. In one example, step 240 includes identifying a permitted time at which the requested transition is permitted at the alternate location. In one example, step 240 may comprise the same or similar operations as steps 220 and 230, however, with respect to different conditions for one or more other locations that may be near the requested location (e.g., within several streets or blocks away, within a half mile, within one mile, or as close to the requested location as a first-identified viable alternate location may be identified. In one example, step 240 may include applying a search algorithm, such as described above.

In one example, step 240 may include calculating a time to reach the intended destination by the dual-mode vehicle, including a time to complete the requested transition, and one of: a time to reach the alternate location via the surface mode of operation, or a time to reach the intended destination from the alternate location via the surface mode of operation. In one example, the alternate location is selected from among a plurality of candidate locations that are different from the requested location, where the processing system calculates a shortest time to reach the intended destination including the requested transition at the alternate location as compared to the requested transition being at other locations of the plurality of candidate locations. In another example, the alternate location is selected from among a plurality of candidate locations that are different from the requested location based upon one of: a shortest distance to the intended destination from the alternate location, or a shortest distance from a current location of the dual-mode vehicle to the alternate location. In still another example, multiple alternate locations may be determined, and the respective times and or distances may be calculated. In one example, the processing system is assigned to the requested location, where one or more additional processing systems are assigned to the plurality of candidate locations for permitting and denying requests for transitions between the two modes of operation for dual-mode vehicles. In such an example, the processing system may identify the alternate location at which the requested transition is permitted via at least one communication with at least one of the one or more additional processing systems. In another example, the processing system is assigned to both the requested location and the alternate location.

At step 250, the processing system transmits a response indicating that the requested transition is permitted at the alternate location. In one example, the response may explicitly or implicitly indicate that the requested transition is not permitted at requested location (or at least not within a relevant time period). In one example, the response comprises an offer with an expiration time. In addition, in one example, the response includes an indication of an anticipated time to reach the destination based upon the requested transition being at the alternate location (e.g., an earliest time at which the dual-mode vehicle may be able to reach the alternate location via a current mode of operation (the aerial mode of operation or surface mode of operation, respectively)). In one example, the response may include indications and/or offers of multiple alternate locations at which the requested transition is permitted, and may also include associated times for which permissions are valid at such alternate locations, the anticipated times to reach the intended destination via transitions as the respective alternate locations, any costs or fees associated with a transition at an alternate location, and so forth.

At optional step 260, the processing system may obtain (e.g., from the dual-mode vehicle) a reply to the offer prior to the expiration time. It should be noted that in one example, the obtaining of the navigational request at step 210, the transmitting of the response at step 250, the obtaining of the reply at optional step 260, and so forth may be via low power wide area (LPWA) cellular communications, such as Narrowband Internet of Things (NB-IoT) communications, Long Term Evolution-Machine Type Communications (LTE-M), and so forth. In this regard, in one example, the processing system (e.g., a local controller) may be associated with a cellular base station (e.g., the processing system may comprise a cellular base station (such a pico-cell, a femto-cell, a gNB, etc.) or may be coupled to or integrated with a cellular base station, where other processing system(s) (e.g., other local controllers) is/are associated with different cellular base station(s) for other areas).

At optional step 270, the processing system may transmit an instruction to at least one traffic signal for surface-based vehicular operations to facilitate the requested transition at the alternate location at the permitted time. For instance, in one example, the instruction is to adjust the traffic signal to diminish (e.g., to at least reduce, and in one example to prevent/stop) surface-based vehicular traffic at the alternate location at a permitted time. For example, the processing system may cause traffic signals to change to red to halt surface-based vehicular traffic at or near the alternate location, or may similarly control other types of traffic signals, such as automated barriers or barricades, and so forth. In one example, the processing system may comprise a controller of a plurality of traffic signals in an area.

Following step 250, or any of the optional steps 260 or 270 the method 200 may proceed to step 295. At step 295, the method 200 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 200, such as steps 210-250, steps 210-270, etc. For instance, the processing system may evaluate further requests to transition between modes of operation for the same dual-mode vehicle or one or more other dual-mode vehicles for various locations within an area assigned to the processing system. In one example, the method 200 may include operations in connection with determining that a requested transition is permitted at a requested location for the same or a different dual-mode vehicle. In one example, the method 200 may include one or more additional steps in connection with tracking the dual-mode vehicle to the alternate destination, confirming that conditions remain acceptable for the requested transition, monitoring for a completion of the requested transition, transmitting instructions to one or more traffic signals to allow the resumption of surface-based vehicular traffic, pedestrian traffic, etc., reporting a violation or non-compliance with a denial of a request for a transition at a requested location, calculating costs or fees associated with the requested transition at the requested location or alternate location(s), where the costs may factor into a determination as to whether to permit or deny the request, may factor into a ranking or recommendation of the requested location versus one or more alternate locations and/or among a plurality of alternate locations, and so forth. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 3 depicts a high-level block diagram of a computing system 300 (e.g., a computing device or processing system) specifically programmed to perform the functions described herein. For example, any one or more components, devices, and/or systems illustrated in FIG. 1, or described in connection with FIG. 2, may be implemented as the computing system 300. As depicted in FIG. 3, the computing system 300 comprises a hardware processor element 302 (e.g., comprising one or more hardware processors, which may include one or more microprocessor(s), one or more central processing units (CPUs), and/or the like, where the hardware processor element 302 may also represent one example of a “processing system” as referred to herein), a memory 304, (e.g., random access memory (RAM), read only memory (ROM), a disk drive, an optical drive, a magnetic drive, and/or a Universal Serial Bus (USB) drive), a module 305 for identifying an alternate location at which a requested transition between operational modes of a dual-mode vehicle is permitted, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 302 is shown, the computing system 300 may employ a plurality of hardware processor elements. Furthermore, although only one computing device is shown in FIG. 3, if the method(s) as discussed above is implemented in a distributed or parallel manner for a particular illustrative example, e.g., the steps of the above method(s) or the entire method(s) are implemented across multiple or parallel computing devices, then the computing system 300 of FIG. 3 may represent each of those multiple or parallel computing devices. Furthermore, one or more hardware processor elements (e.g., hardware processor element 302) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 302 can also be configured or programmed to cause other devices to perform one or more operations as discussed above. In other words, the hardware processor element 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 305 for identifying an alternate location at which a requested transition between operational modes of a dual-mode vehicle is permitted (e.g., a software program comprising computer-executable instructions) can be loaded into memory 304 and executed by hardware processor element 302 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 302) executing the computer-readable instructions relating to the above described method(s) can be perceived as a programmed processor or a specialized processor. As such, the present module 305 for identifying an alternate location at which a requested transition between operational modes of a dual-mode vehicle is permitted (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor, a navigational request for a dual-mode vehicle having two modes of operation, wherein the two modes of operation comprise a surface mode of operation and an aerial mode of operation, wherein the navigational request includes a requested transition between the two modes of operation, wherein the requested transition includes a requested location, and wherein the navigational request includes an intended destination;
determining, by the processing system, at least one condition of the requested location associated with the requested transition;
determining, by the processing system, based upon the at least one condition that the requested transition is not permitted at the requested location;
identifying, by the processing system, an alternate location at which the requested transition is permitted; and
transmitting, by the processing system, a response indicating that the requested transition is permitted at the alternate location.

2. The method of claim 1, wherein the identifying the alternate location at which the requested transition is permitted includes identifying a permitted time at which the requested transition is permitted at the alternate location.

3. The method of claim 2, wherein the response comprises an offer with an expiration time.

4. The method of claim 3, further comprising:
obtaining a reply to the offer prior to the expiration time.

5. The method of claim 4, further comprising:
transmitting an instruction to at least one traffic signal for surface-based vehicular operation to facilitate the requested transition at the alternate location at the permitted time.

6. The method of claim 5, wherein the instruction is to adjust the at least one traffic signal to diminish surface-based vehicular traffic at the alternate location at the permitted time.

7. The method of claim 1, wherein the processing system comprises a controller of a plurality of traffic signals.

8. The method of claim 1, wherein the requested transition is:
a transition from the surface mode of operation to the aerial mode of operation; or
a transition from the aerial mode of operation to the surface mode of operation.

9. The method of claim 1, wherein the at least one condition of the requested location comprises at least one of:
a surface-based vehicular traffic condition;
an aerial vehicular traffic condition;
a weather condition;
a temporal restriction; or
a governmental restriction.

10. The method of claim 1, wherein the at least one condition is determined from at least one of:
a sensor that is deployed at the requested location;
a camera that is deployed at the requested location;
a different dual-mode vehicle at the requested location;
a surface-based vehicle at the requested location;
a radar; or
a notification from an authoritative entity.

11. The method of claim 1, wherein the identifying the alternate location at which the requested transition is permitted includes:
calculating a time to reach the intended destination by the dual-mode vehicle, including a time to complete the requested transition and one of: a time to reach the alternate location via the surface mode of operation, or a time to reach the intended destination from the alternate location via the surface mode of operation.

12. The method of claim 11, wherein the alternate location is selected from among a plurality of candidate locations that are different from the requested location, wherein the processing system calculates a shortest time to reach the intended destination including the requested transition at the alternate location as compared to the requested transition being at other locations of the plurality of candidate locations.

13. The method of claim 1, wherein the alternate location is selected from among a plurality of candidate locations that are different from the requested location based upon one of: a shortest distance to the intended destination from the alternate location, or a shortest distance from a current location of the dual-mode vehicle to the alternate location.

14. The method of claim 1, wherein the processing system is assigned to the requested location, wherein one or more additional processing systems are assigned to the plurality of candidate locations for permitting and denying requests for transitions between the two modes of operation for dual-mode vehicles.

15. The method of claim 14, wherein the processing system identifies the alternate location at which the requested transition is permitted via at least one communication with at least one of the one or more additional processing systems.

16. The method of claim 1, wherein the processing system is assigned to the requested location and the alternate location.

17. The method of claim 1, wherein the obtaining and the transmitting are via a low power wide area cellular link.

18. The method of claim 17, wherein the processing system is associated with a cellular base station.

19. A non-transitory computer-readable medium storing instructions which, when executed by a processing system including at least one processor, cause the processing system to perform operations, the operations comprising:
obtaining a navigational request for a dual-mode vehicle having two modes of operation, wherein the two modes of operation comprise a surface mode of operation and an aerial mode of operation, wherein the navigational request includes a requested transition between the two modes of operation, wherein the requested transition includes a requested location, and wherein the navigational request includes an intended destination;
determining at least one condition of the requested location associated with the requested transition;
determining based upon the at least one condition that the requested transition is not permitted at the requested location;
identifying an alternate location at which the requested transition is permitted; and
transmitting a response indicating that the requested transition is permitted at the alternate location.

20. A device comprising:
a processing system including at least one processor; and
a computer-readable medium storing instructions which, when executed by the processing system, cause the processing system to perform operations, the operations comprising:
obtaining a navigational request for a dual-mode vehicle having two modes of operation, wherein the two modes of operation comprise a surface mode of operation and an aerial mode of operation, wherein the navigational request includes a requested transition between the two modes of operation, wherein the requested transition includes a requested location, and wherein the navigational request includes an intended destination;
determining at least one condition of the requested location associated with the requested transition;
determining based upon the at least one condition that the requested transition is not permitted at the requested location;
identifying an alternate location at which the requested transition is permitted; and
transmitting a response indicating that the requested transition is permitted at the alternate location.
